(19) United States
(12) Patent Application Publication
(10) Pub. No.: US 2016/0108989 A1
(43) Pub. Date: Apr. 21, 2016

(54) FASTENING DEVICE

(71) Applicant: BLUELOUNGE PTE. LTD., Wilkie Edge (SG)

(72) Inventor: Dominic Symons, Wilkie Edge (SG)

(21) Appl. No.: 14/519,395

(22) Filed: Oct. 21, 2014

(51) Int. Cl. F16G 11/10

(52) U.S. Cl. CPC F16G 11/106

(57) ABSTRACT

Novel fastening devices and methods are disclosed. An example of the disclosed fastening device includes an elastomeric cord having a diameter dR in its normal relaxed state. The cord is coupled to a head having a slot formed on the outside of the head to receive the cord. The slot has an opening smaller in diameter than dR of the cord. In this manner, the cord needs to be stretched and thinned out to fit within the slot. When the cord is wrapped around one of more items and then stretched and thinned out to fit within the slot, a secure loop forms around the one or more items. As the cord is released, the head maintains the secure loop around the one or more items without damaging the items and without the need for hooks, hook and loop material, or the like. Depending on the application, the device may further comprise multiple slots and multiple cords. In yet another example, the head may be permanently affixed or mounted to an object, such as the cover of a book, to keep the book closed when not in use.

### BACKGROUND

The present disclosure relates to fastening or bundling devices, ties, straps, or closure tools for wrapping, binding, joining, or the like one or more items using an elastomeric cord.

For years, people have searched for better ways to fasten items together compared to tying knots in a rope or using a twist tie, for example. The advent of the cable tie, also known as a hose tie or zip tie, was a significant improvement over the past. The most common cable tie today consists of an elongated tail section with a pointed tip at one end and a head at the opposite end. The tail section has teeth that engage a pawl in the head to form a ratchet. In use, the pointed tip is pulled through the head to form a loop that may only be pulled tighter. Scissors or similar tools are typically used to cut off the extra tail to be flush with the head. Whether made of metal or plastic, the removed extra tail creates waste that is thrown away and added to already over-burdened landfills.

Moreover, the conventional metal or plastic cable tie does not give and/or flex once tightened. Indeed, nylon cable ties have even been known to shrink over time, causing damage to the cables or items the ties were meant to hold safely together. For at least this reason, use of conventional cable ties in data centers is considered a breach of best practices standards.

Perhaps the most unfortunate drawback with conventional cable ties is that they are generally considered to be single-use devices. While some cable ties are designed for reuse with a tab that may release the ratchet, the common cable tie is typically cut off rather than loosened and reused. The result is even more undue and unwanted waste in landfills.

In an effort to solve the well-known and long-felt problems with the conventional cable tie, some have looked to hook and loop material for an answer. For example, at least one inventor created an elongated strap with hook material on one side or portion that is arranged to interlock with loop material on another side or portion of the strap. While an alternative to the conventional cable tie, the hook and loop strap often fails over time as the hook and/or loop material tends to break down or become damaged with use. To try to fix this problem, a belt-buckle arrangement was added to the strap to give it extra reinforcement. Such an arrangement is unnecessarily complicated and often harmful to the items being secured, such as when the belt buckle scratches or mars one or more of the items, or their surroundings.

Others have looked to some sort of cord having a hook at each end as an answer. Such devices include those black cords, typically made out of ethylene propylene diene monomer (M-class) rubber, with steel S-hooks in the ends. However, over time, this rubber typically develops cracks and breaks. Other such devices include old cloth-sheathed bungee cords with metal S-hooks in the ends. With either the black cords or cloth-sheathed bungee cords, the hooks have a tendency to scratch or mar. In an effort to fix this problem, rubber tips were added to the hooks. However, the rubber tip may fall off and the sharp end of the hook may then scratch or mar adjoining surfaces. More problematic, an exposed hook may dig into wires around which the cord is wrapped, leading short circuits and data transmission failures.

Accordingly, a novel fastening device that is reusable, quickly engageable, simple, and safe to use is desired.

### SUMMARY

One example of the disclosed subject matter is a fastening device including an elastomeric cord having a tail end and an opposing head end, wherein the cord has a diameter dR in its normal relaxed state. The cord is coupled to a head having a slot formed on the outside of the head to receive the cord. The slot has an opening smaller in diameter than dR of the cord. In this manner, the cord needs to be stretched and thinned out to fit within the slot. When the cord is wrapped around one of more items and then stretched and thinned out to fit within the slot, a secure loop forms around the one or more items. As the cord is released, the head maintains the secure loop around the one or more items without damaging the items and without the need for hooks, hook and loop material, or the like.

Another example of the disclosed subject matter is a method of fastening one or more items together. The method comprises holding a head unit coupled to one end of an elastomeric cord, wherein the head unit has a trap adapted to receive the cord, and wherein the trap has an opening that is smaller in diameter compared to that of the cord in a relaxed state. The method further comprises wrapping the other end of the cord about one or more items to be secured, stretching the cord until it is thin enough to fit within the opening of the trap, inserting the cord through the opening of the trap, and releasing the cord to form a tight loop around the one or more items. The trap preferably runs along the length of the outside of the head unit. The cord may be inserted in the trap on the side of the head unit opposite to where the head unit is coupled to the cord, or alternatively inserted on the same side of the head unit where it is coupled to the cord.

Yet another example of the disclosed subject matter is a device comprising a head unit having a top wall, a bottom wall, and two side walls. The head unit includes a trap extending along the length of the top wall and toward the bottom wall. The trap preferably comprises a slide and a chamber, the slide having an opening Oₛ, and the chamber having an opening O_{c}, a width W, and a height H. There is at least one elastic cord coupled to the head unit, wherein the cord has a diameter dR in its normal relaxed state. The slide opening Oₛ is preferably greater than or equal to diameter dR of the cord. The chamber opening O_{c} is preferably smaller than the diameter dR of the cord. The height H of the chamber is preferably smaller than or equal to the diameter dR of the cord. The width W of the chamber is preferably smaller than or equal to the diameter dR of the cord. The head unit may be formed by injection molding around the cord. Alternatively, the device may include a channel disposed along the side walls of the head unit, wherein the channel is adapted to receive and frictionally engage the cord. The chamber of each trap may optionally include teeth.

Depending on the application, the device may further comprise multiple slots or traps and multiple cords. In yet another example, the head may be permanently affixed or mounted to an object, such as the cover of a book, to keep the book closed when not in use.

### BRIEF DESCRIPTION OF THE DRAWINGS

Some non-limiting examples of the disclosed subject matter are illustrated in the following drawings. Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described. Dimensions of components and features shown in the figures are chosen for convenience or clarity of presentation. For convenience or clarity, some elements or structures are not shown or shown only partially and/or with different perspective or from different point of views.

FIG. 1 is a perspective view of an example of the inventions disclosed herein illustrating a fastening device comprising a head and cord with optional tail, wherein the head has one or more channels adapted to frictionally fit the cord opposite the tail;

FIG. 1A is another perspective view of the fastening device seen in FIG. 1;

FIG. 2 is a top view of the head shown in FIGS. 1 and 1A;

FIG. 2A is a cross-section view of the head shown in FIG. 2;

FIG. 3 is a top view of the head shown in FIGS. 1 and 1A illustrating how the head may optionally include teeth disposed along the walls of a chamber cut into the top of the head;

FIG. 4 is a perspective view of the fastening device seen in FIGS. 1 and 1A illustrating how the cord may be pulled through the left side of the head, thus creating a method of fastening objects;

FIG. 5 is a perspective view of the fastening device seen in FIGS. 1 and 1A illustrating how the cord may be pulled through the right side of the head, thus creating another method of fastening objects compared to the method shown in FIG. 4;

FIG. 6 is a perspective view of another example of the inventions disclosed herein illustrating a fastening device comprising a cord and a head co-injected around the cord to mold the head with the cord permanently disposed therewithin;

FIG. 7 is a top view of another example of the inventions disclosed herein illustrating a fastening device comprising multiple cords with an optional tail at one end and a head opposite the tail, wherein the head has two traps adapted to engage the cords for fastening one or more objects together;

FIG. 8 is a top view of another example of the inventions disclosed herein illustrating a fastening device comprising a cord with an optional tail at one end and a head opposite the tail, wherein the head has a trap adapted to engage the cord for securing one or more objects together;

FIG. 9 is a perspective view of another example of the inventions disclosed herein illustrating a fastening device comprising one or more cords with an optional tail at one end and a head opposite the tail, wherein the head is mounted to an object, such as the book shown in FIG. 9, for keeping the book closed when not in use.

### DETAILED DESCRIPTION

A general problem in the field of fastening devices is their typical lack of reusability. A general solution is a novel tool comprising a cord that does not need to be cut; nor does the entire device need to be discarded after use.

A technical problem in the field of fastening devices is how best to hold items together securely and do so without causing damage to the items themselves or their surroundings. A technical solution implementing the spirit of the disclosed inventions is a novel tool comprising a head engineered to hold a cord that stretches and thins out when being wrapped around items and then relaxes once the items are secured. These operations occur all without the need for damaging steel S-hooks or the like.

Potential benefits of the general and technical solutions provided by the disclosed subject matter include those identified above plus the novel fastening device works to secure objects together extremely quickly and with ease. The converse is also true, i.e., the device can be extremely quickly undone to release the objects and with ease.

A general non-limiting overview of practicing the present disclosure is presented below. The overview outlines exemplary practice of embodiments of the present disclosure, providing a constructive basis for variant and/or alternative and/or divergent examples, some of which are subsequently described.

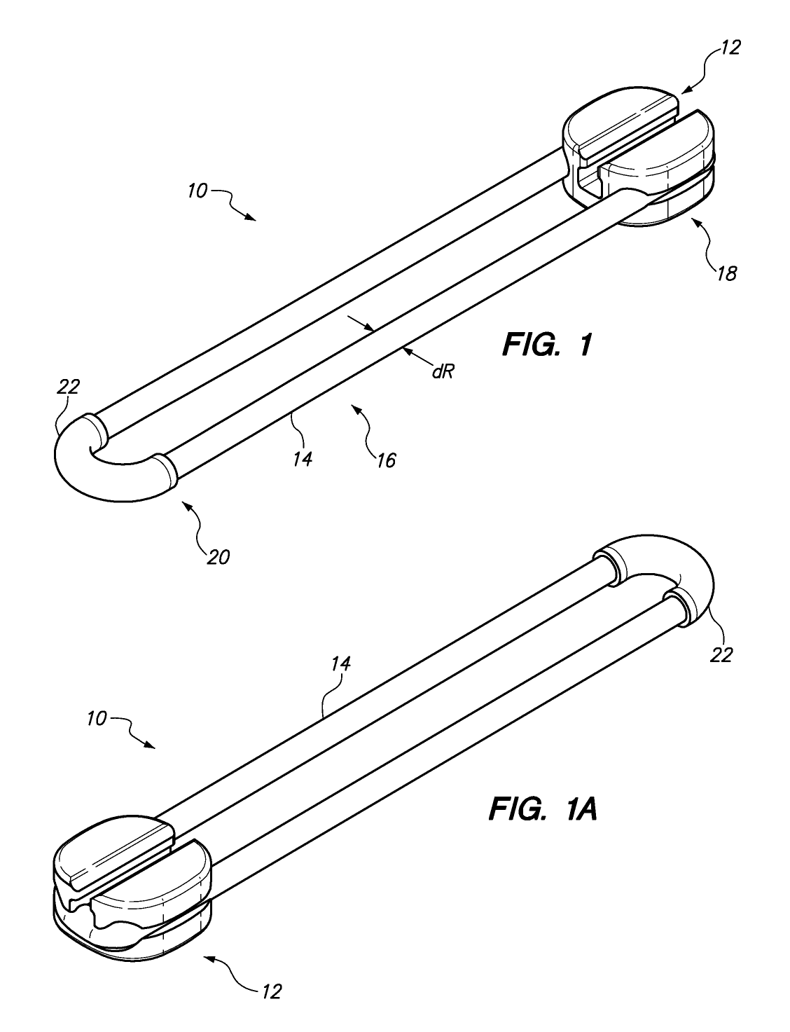

FIG. 1 is a perspective view of an example of the inventions disclosed herein illustrating a fastening device 10 comprising a head 12 and at least one cord 14. Head 12 may be made from a hard plastic or rubber material. If plastic, the head 12 is preferably made via injection molding. Cord 14 is preferably made of an elastomeric material such that when pulled, it will stretch and thin out. FIG. 1 illustrates the elastic cord 14 in a relaxed state having a relaxed diameter dR. FIG. 4 illustrates a portion of the cord 14 in an extended state having a diameter dE, which is smaller in size compared to the relaxed diameter dR.

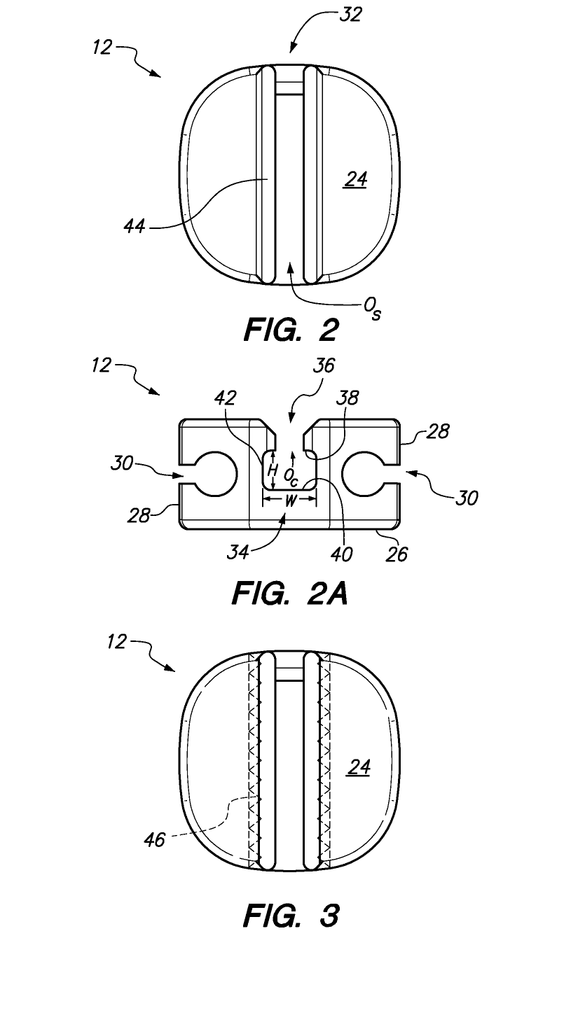

Turning again to FIG. 1, cord 14 is shown as a single piece. This cord 14 may be any length, and when used in conjunction with the head 12, will take on the shape of an extended loop 16 having a first end 18 and an opposing second end 20. Head 12 is shown in FIG. 1 as being associated with end 18 of cord 14, whereas an optional tail 22 is shown as being associated with end 20. Tail 22 may be a separate molded piece adapted to fit around the cord 14, as seen in FIG. 1. Alternatively, tail 22 may be a simple knot formed in the cord 14. Tail 22 provides an additional safety measure when the fastening device 10 is in use to secure objects together since tail 22 cannot be pulled through a slot or trap 32 in the head 12, as discussed below in the context of FIGS. 2-3.

Focusing in detail on FIGS. 2-3, head 12 can be seen having a top wall 24, bottom wall 26, and side walls 28. A channel 30 may be cut within each side wall 28. The channel(s) 30 are designed to frictionally engage cord 12 when looped about the head 12. Slot or trap 32 is ideally disposed intermediate the side walls 28 in the center of the head 12. Trap 32 is preferably comprised of a chamber 34 and slide 36. Slide 36, however, is optional. Chamber 34 is comprised of a top wall 38, bottom wall 40, and side walls 42. Chamber 34 preferably has a width W that is narrower than the relaxed state diameter dR of two cords 14 set side by side for the example seen in FIG. 1. Chamber 34 preferably has a height H that is equal to or slightly smaller than the relaxed state diameter dR of a cord 14. Top wall 38 of chamber 34 has an opening O_{c} that is preferably smaller than the relaxed state diameter dR of a cord 14. Top wall 38 creates an undercut to trap the cords 14 inside the chamber 34.

Slide 36 is in communication with chamber 34 and particularly in communication with opening O_{c} of chamber 34. Slide 36 is preferably conical in shape, as best seen in FIG. 2A, having an opening Oₛ formed in the top wall 24 of the head 12 via chamfers 44 cut therein. Opening Oₛ facilitates the entry of a cord 14 into the chamber 34. A cord 14 having a relaxed state diameter dR cannot be put into or removed from the chamber 34 via opening O_{c}. Conversely, for a cord 14 to be inserted, it must be stretched out until the cord 14 has a thin enough diameter dE to fit through opening O_{c}. As seen in FIG. 3, the chamber 34 may have optional teeth 46 protruding from one or more walls 38, 40, 42 of the chamber 34. Teeth 46 provide additional grip on a cord 14 inserted into the chamber 34.

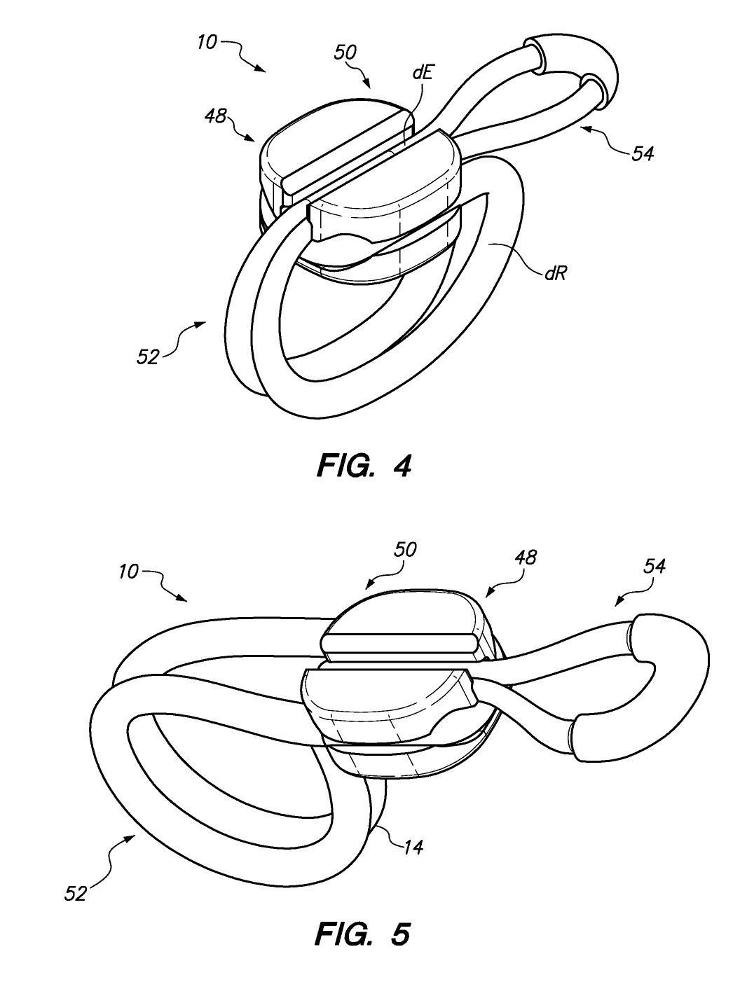

FIGS. 4 and 5 illustrate how the fastening device 10 may be used to secure objects together in two different manners. Turning to FIG. 4, a user places items (not shown) to be secured together under the bottom wall 26 of head 12, wraps the cord 14 about the items, and pulls the cord 14. The cord 14 is pulled to stretch it out of its relaxed state diameter dR until it has a small enough diameter dE to be able to be inserted into the trap 32 of head 12. As seen in FIG. 4, cord(s) 14 are inserted into the left side 48 of head 12. In particular, each cord 14 having diameter dE is passed through opening Oₛ of slide 36 and then into opening O_{c} to be trapped in chamber 34. Once inside chamber 34, the user releases the cords 14 such that the portion of each cord 14 that is not trapped in chamber 34 returns to relaxed state diameter dR. When done, the portion of the cords 14 that is wrapped around the objects acts as a noose or enclosure 52 that secures the objects, with the portion of the cords 14 near the tail 22 forming a ring 54 of sorts.

Turning in detail to FIG. 5, a user would place the objects (not shown) to be secured together to right side 50 of head 12, wrap the cords 14 about the objects, and pull the cords 14. The cords 14 are pulled to stretch them out of their relaxed state diameter dR until each has a small enough diameter dE to be able to be inserted into the trap 32 of head 12. As seen in FIG. 5, cords 14 are inserted into the right side 48 of head 12. In particular, each cord 14 having diameter dE is passed through opening Oₛ of slide 36 and then into opening O_{c} to be trapped in chamber 34. Once inside chamber 34, the user releases the cords 14 such that the portion of each cord 14 that is not trapped in chamber 34 returns to the relaxed state diameter dR. When done, the portion of the cords 14 that is wrapped around the objects acts as a noose or enclosure 52 that secures the objects, with the portion of the cords 14 near the tail 22 forming ring 54 that may be used to hang fastening device from a nail (not shown) or the like.

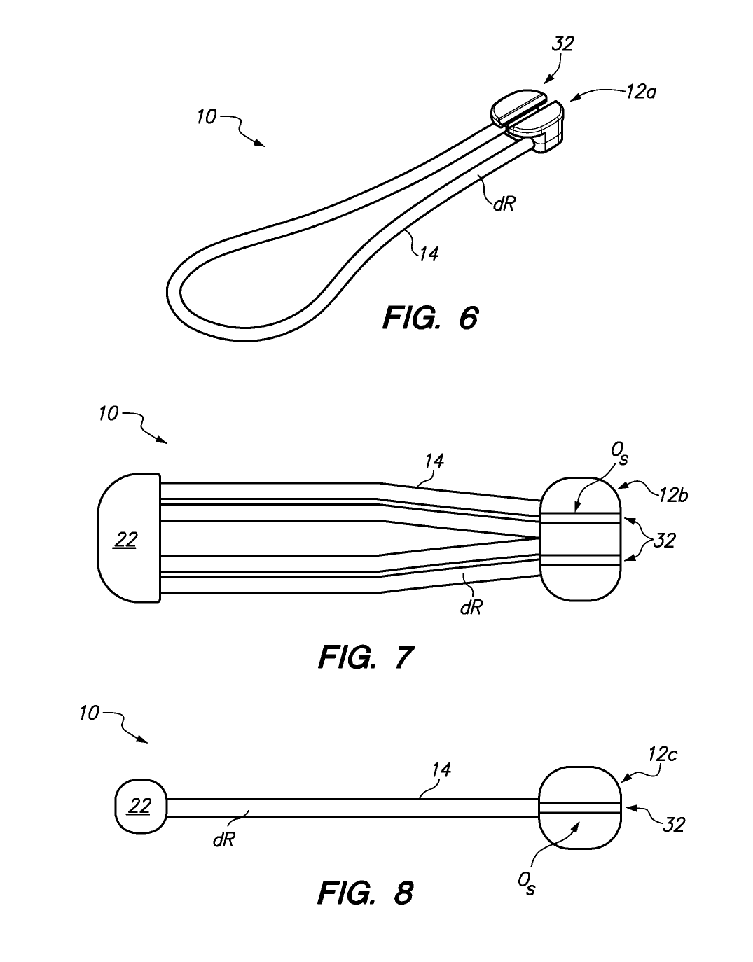

FIG. 6 is a perspective view of another example of the inventions disclosed herein illustrating a fastening device 10 comprising a cord 14 and a head 12a formed by injection molding the head 12 with the cord 14 in the mold such that cord 14 is permanently disposed therewithin. Instead of injection molding, the cord 14 may be permanently attached to the head 12a by other conventional means such as via glue, ultrasonice welding, or the like. With this example, the head 12a does not include a channel(s) for frictionally engaging the cord 14. Moreover, with this example, cord 14 does not include a tail such as tail 22 seen in FIGS. 1-5. All other aspects of the example in FIG. 6 are preferably the same as those in FIGS. 1-5.

FIG. 7 is a top view of another example of the inventions disclosed herein illustrating a fastening device 10 comprising multiple cords 14 with an optional tail 22 at one end and a head 12b opposite the tail 22. The head 12b has two traps 32 adapted to engage the cords 14 for fastening one or more objects (not shown) together. All other aspects of the example shown in FIG. 7 are preferably the same as those in FIGS. 1-5.

FIG. 8 is a top view of another example of the inventions disclosed herein illustrating a fastening device 10 comprising a cord 14 with an optional tail 22 at one end and a head 12c opposite the tail 22. The head 12c has a trap 32 adapted to engage the cord 14 for securing one or more objects (not shown) together. All other aspects of the example shown in FIG. 8 are preferably the same as those in FIGS. 1-5.

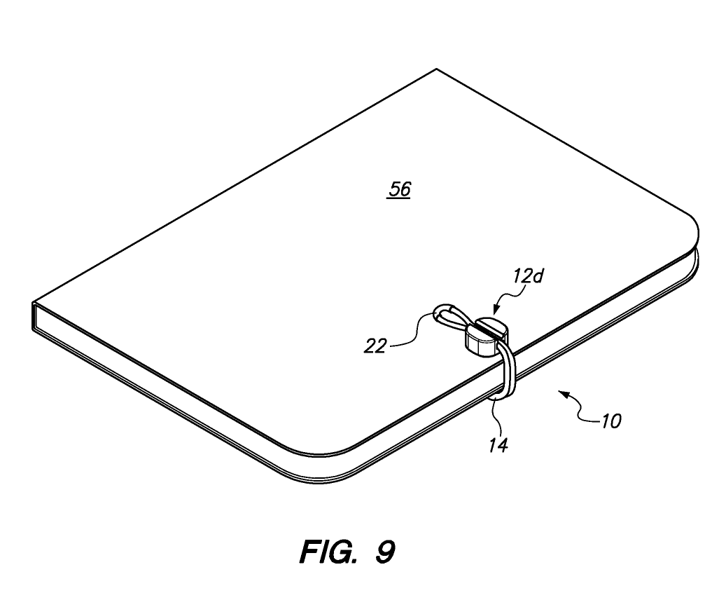

FIG. 9 is a perspective view of another example of the inventions disclosed herein illustrating a fastening device 10 comprising one or more cords 14 with an optional tail 22 at one end and a head 12d opposite the tail 22. The head 12d may be designed to be molded or permanently attached to another object, such as a jacket, shoe, box, note pad, wallet, book, etc., and then the fastening device 10 serves a closure for that object. As seen in FIG. 9, head 12d has been mounted to one side of a book 56, with the cord 14 inserted in the trap 32 for keeping the book 56 closed when not in use.

While certain embodiments have been described, they have been presented by way of example only and are not intended to limit the scope of the inventions. Indeed, the novel methods, kits, and composites described herein may be embodied in a variety of other forms; furthermore, various omissions, substitutions, and changes in the form of the devices and methods described herein may be made without departing from the spirit of the inventions. The accompanying claims and their equivalents are intended to cover such forms or modifications as would fall within the scope and spirit of the inventions.

1. (canceled)

2. The device according to claim 1, wherein the head is formed by injection molding around the cord.

3. (canceled)

4. The device according to claim 3, wherein the head is coupled to the head end of the cord, and further comprising a tail at the tail end of the cord.

5. The device according to claim 1, wherein the head is mounted to an item.

6. A method of fastening one or more items together, the method comprising:
holding a head unit coupled to one end of an elastomeric cord, wherein the head unit has a trap adapted to receive the cord, and wherein the trap has an opening that is smaller in diameter compared to that of the cord in a relaxed state;
wrapping the other end of the cord about one or more items to be secured;
stretching the cord until it is thin enough to fit within the opening of the trap;
inserting the cord through the opening of the trap; and
releasing the cord to form a tight loop around the one or more items.

7. The method of claim 6, wherein the trap runs along the length of the outside of the head unit, and the cord is inserted in the trap on the side of the head unit opposite to where the head unit is coupled to the cord.

8. The method of claim 6, wherein the trap runs along the length of the outside of the head unit, and the cord is inserted in the trap on the same side of the head unit where the head unit is coupled to the cord.

9. A device comprising:
a head unit having a top wall, a bottom wall, and two side walls;
at least one trap extending entirely along the length of the top wall and toward the bottom wall, wherein the at least one trap comprises a slide and a chamber vertically disposed under the slide, the slide having an opening, and the chamber having an opening, a width, and a height; and
at least one elastic cord coupled to the head unit, the at least one cord having a diameter in its normal relaxed state, the slide opening being greater than or equal to diameter of the at least one cord, and the chamber opening being smaller than the diameter of the at least one cord.

10. The device according to claim 9, wherein the height of the chamber is smaller than or equal to the relaxed diameter of the cord.

11. The device according to claim 9, wherein the width of the chamber is smaller than or equal to the relaxed diameter of the at least one cord.

12. The device according to claim 9, wherein the width of the chamber is smaller than or equal to twice the relaxed diameter of the at least one cord.

13. The device according to claim 9, further comprising at least a second trap extending along the length of the top wall and toward the bottom wall, and at least a second elastic cord coupled to the head unit, wherein the second elastic cord has a diameter dR in its normal relaxed state.

14. The device according to claim 13, wherein the width W of the chamber of the first trap is smaller than or equal to the combined diameters dR of the first and second cords.

15. The device according to claim 9, wherein the head unit is formed by injection molding around the cord.

16. The device according to claim 9, wherein the head unit further includes a channel disposed entirely along the side walls of the head unit, wherein the channel is adapted to receive and frictionally engage the at least one cord, and wherein the channel is separated from the trap.

17. The device according to claim 16, wherein the at least one cord is in the shape of an elongated loop with the head unit coupled to one end of the elongated loop, and further comprising a tail at the other end of the elongated loop.

18. The device according to claim 9, wherein the head unit is mounted to an item.

19. The device according to claim 18, wherein the item is a cover of a book.

20. The device according to claim 9, wherein the chamber includes teeth.
